(19) United States
(12) Patent Application Publication
(10) Pub. No.: US 2026/0093552 A1
(43) Pub. Date: Apr. 2, 2026

(54) Computing-in-Memory Macro and Method for Weight Sharing

(71) Applicant: MEDIATEK INC., Hsinchu City (TW)

(72) Inventors: Chieh-Fang Teng, Hsinchu City (TW); En-Jui Chang, Hsinchu City (TW); Hsien-Peng Wang, Hsinchu City (TW); Jen-Wei Liang, Hsinchu City (TW)

(73) Assignee: MEIDATEK INC., Hsinchu City (TW)

(21) Appl. No.: 18/900,941

(22) Filed: Sep. 30, 2024

(51) Int. Cl. G06F 9/50

(52) U.S. Cl. CPC G06F 9/505

(57) ABSTRACT

A method for weight sharing, executed by at least one computing-in-memory macro, the method comprising: a weight memory of a CIM macro of the at least one CIM macro storing a weight; and sending the weight to a plurality of multiply and accumulation (MAC) modules of the at least one CIM module by the weight memory and the weight is shared by the plurality of MAC modules, wherein each of the plurality of MAC modules is in the CIM macro comprises the weight memory or in another CIM macro.

### BACKGROUND

In response to the huge demand for information analysis brought by emerging technologies such as artificial intelligence, the Internet of Things, 5G, and vehicles, governments and internationally renowned manufacturers have actively invested a large amount of resources in recent years to accelerate development while improving computing speed and reducing energy consumption.

Data is the most important resource in today's digital economy. According to estimates, due to the popularity of handheld devices and the development of the internet of things (IoT), more than 2.5 quintillion bytes of data are generated every day, and the rate of data generation is still climbing.

Such a huge amount of data also means that a lot of computing resources are required to process it. Especially when computers currently based on the von Neumann architecture perform calculations, the data must be transferred between the computing unit (CPU or GPU) and the memory. This not only limits the overall efficiency and computing time, but also causes a large amount of energy consumption. This is because repeated data transmission limits performance improvement, resulting in the so-called memory wall.

Entering the era of integrating big data and artificial intelligence (AI), memory-centric chips, which allow memory to more closely integrate computing resources, have received considerable attention in recent years in order to overcome the limitations of the memory wall and improve computing performance.

The so-called memory-centric chip mainly refers to near-memory computing and computing-in-memory (in-memory computing). These two technologies integrate memory and computing. Near-memory computing uses advanced packaging technology to integrate computing chips and memory chips using die-level integration, or integrate computing circuits and memory circuits in a monolithic manufacturing process. The goal of vertical device-level integration is to bring the data computing unit and the memory storage unit closer to reduce the transmission distance.

Computing-in-memory (CIM) overcomes Von Neumann architecture limitations. As for computing-in-memory, it directly uses memory to process artificial neural networks in deep learning, including deep neural network (DNN) and convolutional neural network (CNN). For many neural network computing tasks, there is no need to repeatedly transfer data between the computing unit and the memory, which can overcome the limitations of the Von Neumann architecture and achieve significant improvements in computing performance.

However, when the number of computing-in-memory macros scales up, there may be duplicated weights stored in different CIM macros. A computing-in-memory method with configurable weight sharing is desired to address the duplicated weights in different CIM macros.

### SUMMARY

An embodiment of the present disclosure provides a method for weight sharing, executed by at least one computing-in-memory macro, the method comprising: a weight memory of a CIM macro of the at least one CIM macro storing a weight; and sending the weight is sent to a plurality of multiply and accumulation (MAC) modules of the at least one CIM module by the weight memory and the weight is shared by the plurality of MAC modules, wherein each of the plurality of MAC modules is in the CIM macro comprises the weight memory or in another CIM macro.

In another embodiment, the present disclosure provides a computing-in-memory (CIM) macro, comprising: a plurality of weight memories, each of the plurality of weight memories is configured to store weights; and a plurality of multiply and accumulation (MAC) modules, wherein each of the plurality of the MAC modules is connected to at least one of the plurality of weight memories directly or by at least one multiplexer to obtain the weights stored by the at least one weight memory.

In another embodiment, the present disclosure provides a computing-in-memory (CIM) macro, comprising: a weight memory, configured to store weights; and a multiply and accumulation (MAC) module, connected to the weight memory directly or by a multiplexer; wherein the weight memory is connected to at least one MAC module outside the CIM macro directly or by at least one multiplexer, and the weights stored in the weight memory are accessed by the at least one MAC module outside the CIM macro.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a computing-in-memory macro with configurable weight sharing according to an embodiment of the present disclosure.

FIG. 2 is a block diagram of inter macros for computing-in-memory with configurable weight sharing according to an embodiment of the present disclosure.

FIG. 3 is a block diagram of an intra macro for computing-in-memory with configurable weight sharing according to an embodiment of the present disclosure.

FIG. 4 is a flowchart of a method for weight sharing.

FIG. 5A is a schematic diagram of a convolutional neural network (CNN) application using different weights according to an embodiment of the present disclosure.

FIG. 5B is a schematic diagram of a CNN application using duplicated weights according to an embodiment of the present disclosure.

### DETAILED DESCRIPTION

Separating the central processing unit (CPU) from the memory is not perfect and can lead to the so-called Von Neumann bottleneck: the flow rate (data transfer rate) between the CPU and memory is quite small compared to the memory capacity. In modern computers, the data flow is very small compared to the CPU's work efficiency. In some cases (when the CPU needs to execute some simple instructions on huge data), the data flow becomes a very serious limitation on the overall efficiency. The CPU will be idle while data is being input or output to memory. Since the CPU speed is much greater than the memory read and write rate, the bottleneck problem becomes more and more serious. Therefore, computing-in-memory technology is desired.

In applications of artificial intelligence (AI), memory usage is an essential issue. Huge amount of weights are applied in AI applications especially in deep neural network (DNN) and convolutional neural network (CNN). In CNN applications, duplicated weights are utilized several times during inference. Therefore, in a computing-in-memory application, there is a need for an efficient method to share duplicated weights.

The present disclosure provides a method for weight sharing, executed by at least one computing-in-memory macro, the method comprising: a weight memory of a CIM macro of the at least one CIM macro stores a weight; and the weight is sent to a plurality of multiply and accumulation (MAC) modules of the at least one CIM module by the weight memory to be shared by the plurality of MAC modules, wherein each of the plurality of MAC modules is in the CIM macro comprises the weight memory or in another CIM macro. Wherein the weight is sent to a plurality of MAC modules by the weight memory further comprises: the weight is sent to a subset or all of the plurality of MAC modules directly by the weight memory, or the weight is sent to a plurality of MAC modules by the weight memory further comprises: the weight is sent to at least one multiplexer by the weight memory; and the at least one multiplexer selects the weight as output weight and sends the output weight to a subset or all of the plurality of the MAC modules.

Or the weight is sent to a plurality of MAC modules by the weight memory further comprises: the weight is sent to at least one MAC module of the plurality of MAC modules directly by the weight memory; and the weight is also sent to at least one multiplexer by the weight memory, the at least one multiplexer selects the weight as output weight and sends the output weight to a subset or all of the plurality of the MAC modules.

In an embodiment, the method further comprising: the weight is sent to at least one multiplexer by the weight memory; and the at least one multiplexer selects the weight or another weight as output weight and sends the output weight to a subset or all of the plurality of the MAC modules or sends the output weight to at least one other multiplexer.

In an embodiment, when execute the method, the at least one multiplexer receives another weight from a weight memory that is different from the weight memory or from other multiplexer.

In an embodiment, when execute the method, the at least one CIM macro comprises an intra macro which comprises a first number of weight memories and a second number of MAC modules, wherein each of the first number of weight memories connects to a MAC module of the second number of MAC modules directly or by at least one multiplexer.

In an embodiment, when execute the method, the at least one CIM macro forms an inter macros, and each CIM macro of the at least one CIM macro comprises a weight memory and a MAC module, wherein each weight memory in the inter macros connects to at least one MAC module in the inter macros directly or by at least one multiplexer.

In an embodiment, when execute the method, the at least one CIM macro comprises at least one intra macro and inter macros, wherein: each intra macro comprises a plurality of weight memories and a plurality of MAC modules; and each CIM macro in the inter macros comprises a weight memory and a MAC module; wherein each weight memory in at least one CIM macro connects to at least one MAC module in at least one CIM macro directly or by at least one multiplexer.

In an embodiment, the method is applied to a convolutional neural network (CNN) application.

The present disclosure also provides a computing-in-memory (CIM) macro, comprising: a plurality of weight memories, each of the plurality of weight memories is configured to store weights; and a plurality of multiply and accumulation (MAC) modules, wherein each of the plurality of the MAC modules is connected to at least one weight memory of the plurality of weight memories directly or by at least one multiplexer so as to obtain the weights stored by the at least one weight memory. Wherein the CIM macro is an intra macro. In an embodiment, the CIM macro is a first CIM macro, wherein the first CIM macro comprises a first weight memory which connects to at least one MAC modules outside the first CIM macro directly or by at least one multiplexer, so as to the at least one MAC modules outside the first CIM macro can obtain the weights stored by the first weight memory. In an embodiment, when a MAC module is connected to at least one weight memory of the plurality of weight memories by at least one multiplexer, each of the at least one multiplexer is configured to select one of its input weights as output weight and sends the output weight.

The present disclosure provides another computing-in-memory (CIM) macro, comprising: a weight memory, is configured to store weights; and a multiply and accumulation (MAC) module, wherein the MAC module is connected to the weight memory directly or by a multiplexer; wherein the weight memory is connected to at least one MAC module outside the CIM macro directly or by at least one multiplexer so as to the at least one MAC module outside the CIM macro can obtain the weights stored by the weight memory. Wherein the MAC module of another CIM macro is further connected to at least one weight memory outside the CIM macro directly or by at least one multiplexer so as to obtain the weights stored by the at least one weight memory outside the CIM macro. Wherein the CIM macro is a part of inter macros, wherein each CIM macro in the inter macros comprises a weight memory and a MAC module; Wherein each weight memory in the inter macros is connected to at least one MAC module in the inter macros directly or by at least one multiplexer. Wherein when a MAC module is connected to a weight memory by at least one multiplexer, each of the at least one multiplexer is configured to select one of its input weights as output weight and sends the output weight.

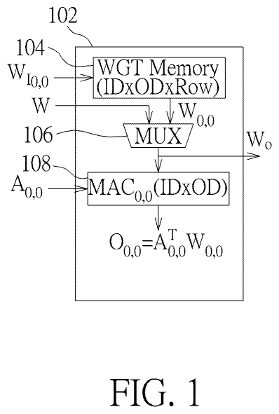

FIG. 1 is a block diagram of a computing-in-memory macro 102 with configurable weight sharing according to an embodiment of the present disclosure. The computing-in-memory (CIM) macro 102 comprises a weight memory 104 with dimensions ID×OD×Row, wherein ID represents input dimension, OD represents output dimension, and Row represents Rows of ID×OD weights a weight memory can store, a multiplexer (MUX) 106 with configuration and a multiply and accumulation (MAC) module 108 with dimensions ID×OD. A normal CIM process comprises inputting weights W_{0,0} with dimension ID×OD to the MAC module 108 from the weight memory 104, and outputting output O_{0,0} from the MAC module 108. The output can be calculated as follows:

$${O}_{0 , 0} = {A}_{0 , 0}^{T} {W}_{0 , 0}$$

Where O_{0,0} is an output with dimension OD,

$${A}_{0 , 0}^{T}$$

is a transpose of an activation with dimension ID, W_{0,0} is a weight with dimensions ID×OD and obtained from W_{I0,0}.

In an embodiment of the present disclosure, the multiplexer 106 is configured to output a weight Wₒ selected from the weight W_{0,0} from the weight memory 104 and the weight W from other module, the other module may be a module inside or outside the CIM macro 102. For example, the other module may be another weight memory or another MUX inside or outside the CIM macro 102. The weight Wₒ is outputted from the multiplexer 106 to the MAC module 108 and another multiplexer. It should be noticed that the structure of the CIM macro 102 in FIG. 1 is merely an example and is not intended to limit the scope of the present disclosure. In this disclosure, the CIM macro 102 may comprise at least one weight memory, at least one MUX, and at least one MAC module which are configured to support weight sharing. In some embodiments, the MUX of the disclosure selects one of its input weights as output based on the requirements of at least one MAC module it connects. For example, in FIG. 1, the MAC module 108 needs W_{0,0} to execute its MAC operation, thus, MUX 106 is configured to output a weight Wₒ selected from the weight W_{0,0} from the weight memory 104 or the weight W from other module.

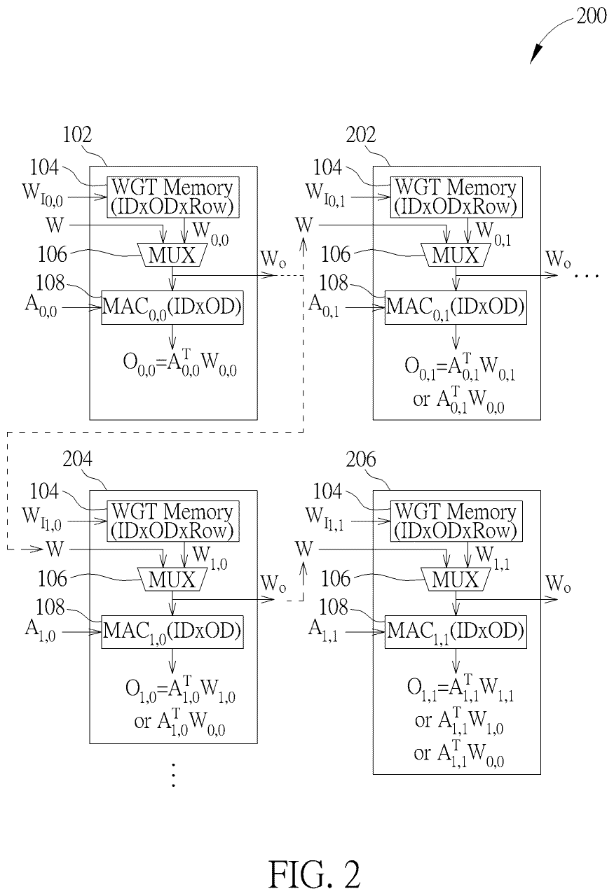

FIG. 2 is a block diagram of inter macros 200 for computing-in-memory with configurable weight sharing according to an embodiment of the present disclosure. The inter macros 200 comprise N macros. Each macro 102, 202, 204, 206 comprises a weight memory 104, a multiplexer 106 and a MAC module 108. In the macro 102, the weight memory 104 outputs a weight W_{0,0} to the multiplexer 106. The multiplexer 106 outputs the weight W_{0,0} to the MAC module 108. The MAC module 108 calculates an output O_{0,0} by:

$${O}_{0 , 0} = {A}_{0 , 0}^{T} {W}_{0 , 0}$$

Where O_{0,0} is the output with a dimension OD of the macro 102,

$${A}_{0 , 0}^{T}$$

is a transpose of an activation with a dimension ID of the macro 102, W_{0,0} is the weight with dimensions ID×OD of the macro 102.

The weight W_{0,0} is also sent to the macro 202. The weight W_{0,0} is thus shared by the macro 202 to reduce power consumption, memory read/write and thus increase overall memory storage space.

In an embodiment, the macro 102 is the first macro of the inter macros 200. Thus the multiplexer 106 can have only one input, just to receive the weight W_{0,0} from the weight memory 104. Since the multiplexer 106 has only one input, the multiplexer 106 of the macro 102 can be omitted. However, though the macro 102 is the first macro of the inter macros 200, the multiplexer 106 can still receive weights from other macros, and output a weight selected from the weights from other macros and the weight W_{0,0} from the weight memory 104.

In addition, the multiplexer 106 can output the weight W_{0,0} to multiplexers in other macros. In an embodiment, if the weight W_{0,0} needs to be used by other macros, the multiplexer 106 can be coupled to the multiplexers in other macros to provide the weight W_{0,0}.

In the macro 202, the weight memory 104 outputs a weight W_{0,1} (obtained from W_{I0,1}) to the multiplexer 106. The weight W_{0,0} is also inputted to the multiplexer 106. The multiplexer 106 outputs the weight W_{0,1} or the weight W_{0,0} to the MAC module 108 according to its configuration. The MAC module 108 calculates an output O_{0,1} by:

$${O}_{0 , 1} = {A}_{0 , 1}^{T} {W}_{0 , 1} or {A}_{0 , 1}^{T} {W}_{0 , 0}$$

Where O_{0,1} is the output with a dimension OD of the macro 202,

$${A}_{0 , 1}^{T}$$

is a transpose of an activation with a dimension ID of the macro 202, and W_{0,1} is the weight with dimensions ID×OD of the macro 202.

In an embodiment, the multiplexer 106 of the macro 202 can still receive weights from other macros, not just the macro 102, and output a weight selected from the weight W_{0,0}, the weights from other macros, and the weight W_{0,1} from the weight memory 104.

In addition, the multiplexer 106 can output the weight W_{0,1} or the weight W_{0,0} to multiplexers in other macros. In an embodiment, if the weight W_{0,1} or the weight W_{0,0} needs to be used by other macros, the multiplexer 106 can be coupled to the multiplexers in other macros to provide the weight W_{0,1} or the weight W_{0,0}.

In the macro 204, the weight memory 104 outputs a weight W_{1,0} (obtained from W_{I1,0}) to the multiplexer 106. The weight W_{0,0} is also inputted to the multiplexer 106. The multiplexer 106 outputs the weight W_{1,0} or the weight W_{0,0} to the MAC module 108 according to its configuration. The MAC module 108 calculates an output O_{1,0} by:

$${O}_{1 , 0} = {A}_{1 , 0}^{T} {W}_{1 , 0} or {A}_{1 , 0}^{T} {W}_{0 , 0}$$

Where O_{1,0} is the output with a dimension OD of the macro 204,

$${A}_{1 , 0}^{T}$$

is a transpose of an activation with a dimension ID of the macro 204, and W_{1,0} is the weight with dimensions ID×OD of the macro 204.

In an embodiment, the multiplexer 106 of the macro 204 can still receive weights from other macros, not just the macro 102, and output a weight selected from the weight W_{0,0}, the weights from other macros, and the weight W_{1,0} from the weight memory 104.

In addition, the multiplexer 106 can output the weight W_{1,0} or the weight W_{0,0} to multiplexers in other macros. In an embodiment, if the weight W_{1,0} or the weight W_{0,0} needs to be used by other macros, the multiplexer 106 can be coupled to the multiplexers in other macros to provide the weight W_{1,0} or the weight W_{0,0}.

In the macro 206, the weight memory 104 outputs a weight W_{1,1} (obtained from W_{I1,1}) to the multiplexer 106. The weight W_{1,0} or the weight W_{0,0} is also inputted to the multiplexer 106. The multiplexer 106 outputs the weight W_{1,1}, the weight W_{1,0} or the weight W_{0,0} to the MAC module 108 according to its configuration. The MAC module 108 calculates an output O_{1,1} by:

$${O}_{1 , 1} = {A}_{1 , 1}^{T} {W}_{1 , 1} or {A}_{1 , 1}^{T} {W}_{1 , 0} or {A}_{1 , 1}^{T} {W}_{0 , 0}$$

Where O_{1,1} is the output with a dimension OD of the macro 206,

$${A}_{1 , 1}^{T}$$

is a transpose of an activation with a dimension ID of the macro 206, and W_{1,1} is the weight with dimensions ID×OD of the macro 206.

In an embodiment, the multiplexer 106 of the macro 206 can still receive weights from other macros, not just the macro 204, and output a weight selected from the weight W_{1,0} or W_{0,0}, the weights from other macros, and the weight W_{1,1} from the weight memory 104.

In addition, the multiplexer 106 can output the weight W_{1,1}, or the weight W_{1,0} or W_{0,0} to multiplexers in other macros. In an embodiment, if the weight W_{1,1}, or the weight W_{1,0} or W_{0,0} needs to be used by other macros, the multiplexer 106 can be coupled to multiplexers in other macros to provide the weight W_{1,1}, or the weight W_{1,0} or W_{0,0}.

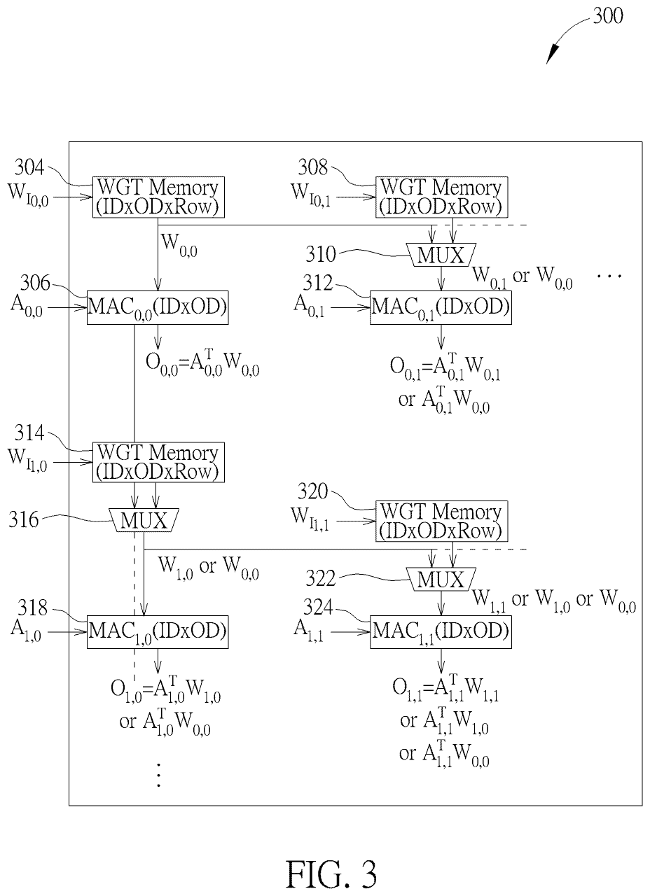

FIG. 3 is a block diagram of an intra macro 300 for computing-in-memory with configurable weight sharing according to an embodiment of the present disclosure. The intra macro 300 comprises four weight memories 304, 308, 314, 320, three multiplexers 310, 316, 322 and four MAC modules 306, 312, 318, 324. The weight memory 304 outputs a weight W_{0,0} to the MAC module 306. The MAC module 306 calculates an output O_{0,0} by:

$${O}_{0 , 0} = {A}_{0 , 0}^{T} {W}_{0 , 0}$$

Where O_{0,0} is the output with a dimension OD of the MAC module 306,

$${A}_{0 , 0}^{T}$$

is a transpose of an activation with a dimension ID of the MAC module 306, W_{0,0} is the weight with dimensions ID×OD of the weight memory 304.

The weight W_{0,0} is also sent to the multiplexer 310. The weight W_{0,0} is thus shared by the multiplexer 310 to reduce power consumption, memory read/write, and thus increase overall memory storage space.

In an embodiment, the weight W_{0,0} is the first weight of the intra macro 300. Since the weight W_{0,0} is the only option to be received by the MAC module 306, the weight W_{0,0} is outputted from the weight memory 304 to the MAC module 306 without passing through a multiplexer. However, the multiplexer can be disposed between the weight memory 304 and the MAC module 306, especially if the multiplexer is to receive additional weights from other multiplexers 310, 316, 322, and output a weight selected from the weights from other multiplexers 310, 316, 322 and the weight W_{0,0} from the weight memory 304.

In addition, the weight memory 304 can output the weight W_{0,0} to other multiplexers. In an embodiment, if the weight W_{0,0} needs to be used by other multiplexers 310, 316, 322, the weight memory 304 can be coupled to the multiplexers 310, 316, 322 to provide the weight W_{0,0}.

In FIG. 3, the weight memory 308 outputs a weight W_{0,1} to the multiplexer 310. The weight W_{0,0} is also inputted to the multiplexer 310. The multiplexer 310 outputs the weight W_{0,1} or the weight W_{0,0} to the MAC module 312 according to its configuration. The MAC module 312 calculates an output O_{0,1} by:

$${O}_{0 , 1} = {A}_{0 , 1}^{T} {W}_{0 , 1} or {A}_{0 , 1}^{T} {W}_{0 , 0}$$

Where O_{0,1} is the output with a dimension OD of the MAC module 312,

$${A}_{0 , 1}^{T}$$

is a transpose of an activation with a dimension ID of the MAC module 312, and W_{0,1} is the weight with dimensions ID×OD of the MAC module 312.

In an embodiment, the multiplexer 310 can still receive weights from other multiplexers, not just the weight W_{0,0}, and output a weight selected from the weight W_{0,0}, the weights from other multiplexers, and the weight W_{0,1} from the weight memory 308.

In addition, the multiplexer 310 can output the weight W_{0,1} or the weight W_{0,0} to other multiplexers. In an embodiment, if the weight W_{0,1} or the weight W_{0,0} needs to be used by other multiplexers, the multiplexer 310 can be coupled to other multiplexers to provide the weight W_{0,1} or the weight W_{0,0}.

In FIG. 3, the weight memory 314 outputs a weight W_{1,0} to the multiplexer 316. The weight W_{0,0} is also inputted to the multiplexer 316 from the weight memory 304. The multiplexer 316 outputs the weight W_{1,0} or the weight W_{0,0} to the MAC module 318 according to its configuration. The MAC module 318 calculates an output O_{1,0} by:

$${O}_{1 , 0} = {A}_{1 , 0}^{T} {W}_{1 , 0} or {A}_{1 , 0}^{T} {W}_{0 , 0}$$

Where O_{1,0} is the output with a dimension OD of the MAC module 318,

$${A}_{1 , 0}^{T}$$

is a transpose of an activation with a dimension ID of the MAC module 318, and W_{1,0} is the weight with dimensions ID×OD of the MAC module 318.

In an embodiment, the multiplexer 316 can still receive weights from other multiplexers, not just the weight memory 304, and output a weight selected from the weight W_{0,0}, the weights from other multiplexers, and the weight W_{1,0} from the weight memory 314.

In addition, the multiplexer 316 can output the weight W_{1,0} or the weight W_{0,0} to other multiplexers. In an embodiment, if the weight W_{1,0} or the weight W_{0,0} needs to be used by other multiplexers, the multiplexer 316 can be coupled to other multiplexers to provide the weight W_{1,0} or the weight W_{0,0}.

In FIG. 3, the weight memory 320 outputs a weight W_{1,1} to the multiplexer 322. The weight W_{1,0} or the weight W_{0,0} is also inputted to the multiplexer 322. The multiplexer 322 outputs the weight W_{1,1}, or the weight W_{1,0} or W_{0,0} to the MAC module 324 according to its configuration. The MAC module 324 calculates an output O_{1,1} by:

$${O}_{1 , 1} = {A}_{1 , 1}^{T} {W}_{1 , 1} or {A}_{1 , 1}^{T} {W}_{1 , 0} or {A}_{1 , 1}^{T} {W}_{0 , 0}$$

Where O_{1,1} is the output with a dimension OD of the MAC module 324,

$${A}_{1 , 1}^{T}$$

is a transpose of an activation with a dimension ID of the MAC module 324, and W_{1,1} is the weight with dimensions ID×OD of the MAC module 324.

In an embodiment, the multiplexer 322 can still receive weights from other multiplexers, not just the multiplexer 316, and output a weight selected from the weight W_{1,0} or W_{0,0}, the weights from other multiplexers, and the weight W_{1,1} from the weight memory 320.

In addition, the multiplexer 322 can output the weight W_{1,1}, or the weight W_{1,0} or W_{0,0} to other multiplexers. In an embodiment, if the weight W_{1,1}, or the weight W_{1,0} or W_{0,0} needs to be used by other multiplexers, the multiplexer 322 can be coupled to other multiplexers to provide the weight W_{1,1}, or the weight W_{1,0} or W_{0,0}.

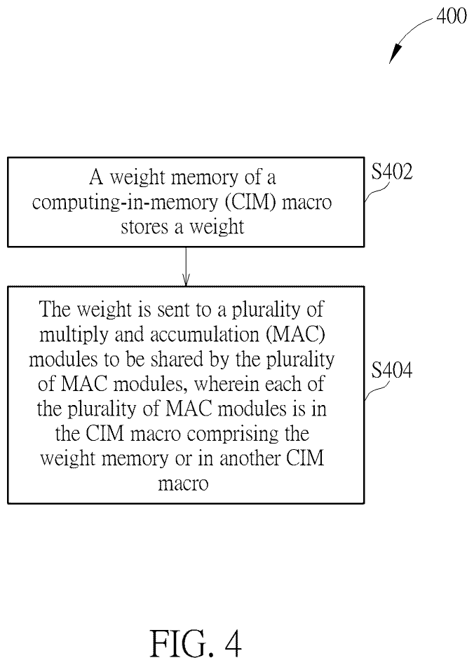

FIG. 4 is a flowchart of a method 400 for weight sharing. The method can be implemented by the CIM macros in FIGS. 1-3, the method includes the following steps:

Step S402: a weight memory of a computing-in-memory (CIM) macro stores a weight;

Step S404: the weight is sent to a plurality of multiply and accumulation (MAC) modules to be shared by the plurality of MAC modules, wherein each of the plurality of MAC modules is in the CIM macro comprising the weight memory or in another CIM macro.

In some embodiments, in Step S404, the weight is sent to a subset or all of the plurality of the MAC modules directly by the weight memory. In other embodiments, in Step S404, the weight is sent to at least one multiplexer, and the at least one multiplexer selects the weight as output weight and sends the output weight to a subset or all of the plurality of the MAC modules.

Please refer to both FIG. 2 and FIG. 4, take the weight memory 104 in CIM macro 102 as an example, in step S402, weight memory 104 stores a weight W_{0,0}. In step S404, the weight W_{0,0} is sent to the MAC module 108 of the CIM macro 102 by MUX 106 of the CIM macro 102, meanwhile, the weight W_{0,0} is also sent to the MAC module 108 of the CIM macro 202 by MUX 106 of the CIM macro 202. Besides, the weight W_{0,0} may be sent to the MAC module 108 of the CIM macro 204 by MUX 106 of the CIM macro 204 and/or sent to the MAC module 108 of the CIM macro 206 by MUX 106 of the CIM macro 206. As a result, the weight W_{0,0} stored in the weight memory 104 of the CIM macro 102 can be shared by multiple CIM macros (e.g., the inter macros 200).

Please refer to both FIG. 3 and FIG. 4, take weight memory 304 as an example, in step S402, weight memory 304 stores a weight W_{0,0}. In step S404, the weight W_{0,0} is sent to the MAC module 306 directly by weight memory 304, meanwhile, the weight W_{0,0} is also sent to the MAC module 312 by MUX 322. Besides, although unshown, the weight W_{0,0} may be sent to other MAC module directly by the weight memory 304 or by other MUX. As a result, the weight W_{0,0} stored in the weight memory 304 can be shared by an intra macro (e.g., the intra macro 300).

Please refer to both FIG. 3 and FIG. 4, take weight memory 314 as an example, in step S402, weight memory 314 stores a weight W_{1,0}. In step S404, the weight W_{1,0} is sent to the MAC module 318 by MUX 316, meanwhile, the weight W_{1,0} is also sent to the MAC module 324 by MUX 322. Besides, although unshown, the weight W_{1,0} may be sent to other MAC module by other MUX. As a result, the weight W_{1,0} stored in the weight memory 314 can be shared by an intra macro (e.g., the intra macro 300).

In other embodiments, an intra macro (e.g., the intra macro 300) can be connected to inter macros (e.g., the inter macros 200), thus a weight of a weight memory of an intra macro may be shared by the inter macros, and a weight of a weight memory of any macro of the inter macros may be shared by the intra macro.

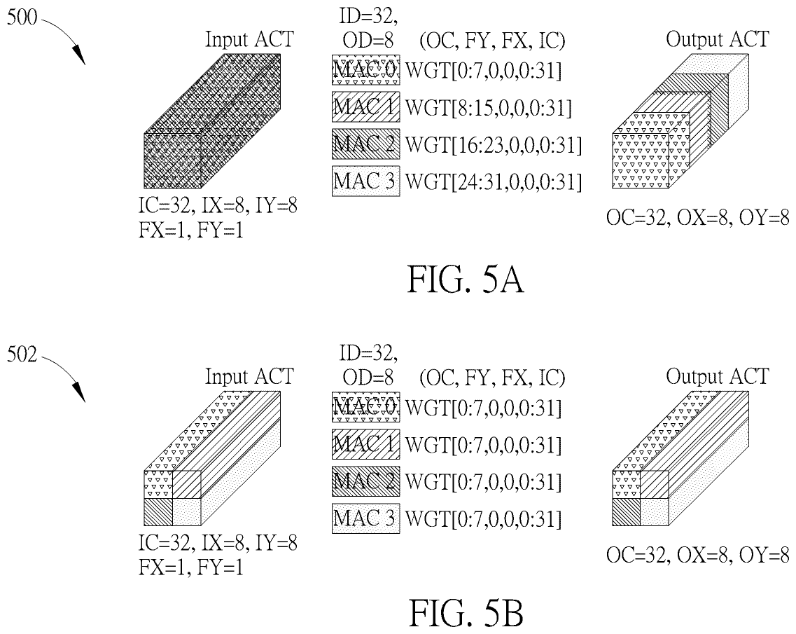

FIG. 5A is a schematic diagram of a convolutional neural network (CNN) application 500 using different weights according to an embodiment of the present disclosure. In FIG. 5A, MAC0 (represents MAC module 0) performs weight operation on weight WGT[0:7,0,0,0:31], wherein WGT[0:7,0,0,0:31] means output channels are 0 to 7 and the OD is 8, filter Y is 0, filter X is 0, and input channels are 0 to 31 and the ID is 32. The input channels represent the channels used for inputting data to the CNN. The filter Y represents the filter in y direction used in convolution layer of the CNN. The filter X represents the filter in x direction used in convolution layer of the CNN. The output channels represent the channels used for outputting data from the CNN. MAC1 (represents MAC module 1) performs weight operation on weight WGT[8:15,0,0,0:31]), wherein WGT[8:15,0,0,0:31] means output channels are 8 to 15, filter Y is 0, filter X is 0, and input channels are 0 to 31. MAC2 (represents MAC module 2) performs weight operation on weight WGT[16:23,0,0,0:31], wherein WGT[16:23,0,0,0:31] means output channels are 16 to 23, filter Y is 0, filter X is 0, and input channels are 0 to 31. MAC3 (represents MAC module 3) performs weight operation on weight WGT[24:31,0,0,0:31], wherein WGT[24:31,0,0,0:31] means output channels are 24 to 31, filter Y is 0, filter X is 0, and input channels are 0 to 31. Because MAC0-MAC3 use the same input channels, their input activations are the same. The input activations are used to multiply with the weights to generate output activations. Because MAC0-MAC3 have different output channels and their input activations are the same, their output activations are in parallel on OC dimension. Furthermore, since MAC0-MAC3 have different output channels, MAC0-MAC3 have different weights, requiring no weight sharing. Thus corresponding multiplexers are all configured to use weights from the weight memories.

FIG. 5B is a schematic diagram of a CNN application 502 using duplicated weights according to an embodiment of the present disclosure. In FIG. 5B, MAC0 performs weight operation on weight WGT[0:7,0,0,0:31], wherein WGT[0:7,0,0,0:31] means output channels are 0 to 7, filter Y is 0, filter X is 0, and input channels are 0 to 31. MAC1 also performs weight operation on weight WGT[0:7,0,0,0:31]. MAC2 also performs weight operation on weight WGT[0:7,0,0,0:31]. MAC3 also performs weight operation on weight WGT[0:7,0,0,0:31]. Because MAC0-MAC3 use the same input channels but different regions, their input activations are different. The input activations are used to multiply with the weights to generate output activations. Because MAC0-MAC3 have the same output channels, their output activations are in parallel on OX and OY dimensions. Furthermore, since MAC0-MAC3 have the same output channels, MAC0-MAC3 have the same weight WGT[0:7,0,0,0:31], the weight sharing structure and method of the present disclosure is beneficial in FIG. 5B, specifically, in FIG. 5B a weight WGT[0:7,0,0,0:31] stored in a weight memory is sent and shared by MAC0-MAC3 by sending the WGT[0:7,0,0,0:31] to MAC0-MAC3 directly or by multiplexers. The multiplexers in this disclosure are used to select one of a plurality of weights to be sent to a corresponding MAC.

In conclusion, the method for weight sharing can be performed in the same macro or across different macros, and a weight can be shared among the plurality of MAC modules within the same macro or across different macros. In conclusion, the present disclosure can reduce memory resource, power consumption and increase overall storage space.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A method for weight sharing, executed by at least one computing-in-memory macro, the method comprising:
a weight memory of a CIM macro of the at least one CIM macro storing a weight; and
sending the weight to a plurality of multiply and accumulation (MAC) modules of the at least one CIM module by the weight memory and the weight is shared by the plurality of MAC modules, wherein each of the plurality of MAC modules is in the CIM macro comprises the weight memory or in another CIM macro.

2. The method of claim 1, wherein the step of sending the weight to a plurality of MAC modules by the weight memory further comprises:
sending the weight to a subset or all of the plurality of MAC modules directly by the weight memory.

3. The method of claim 1, wherein the step of sending the weight to a plurality of MAC modules by the weight memory further comprises:
sending the weight to at least one multiplexer by the weight memory; and
the at least one multiplexer selecting the weight as output weight and sending the output weight to a subset or all of the plurality of the MAC modules.

4. The method of claim 1, wherein the weight is sent to a plurality of MAC modules by the weight memory further comprises:
sending the weight to at least one MAC module of the plurality of MAC modules directly by the weight memory; and
sending the weight to at least one multiplexer by the weight memory, the at least one multiplexer selecting the weight as output weight and sending the output weight to a subset or all of the plurality of the MAC modules.

5. The method of claim 1, further comprising:
sending the weight to at least one multiplexer by the weight memory; and
the at least one multiplexer selecting the weight or another weight as output weight and sending the output weight to a subset or all of the plurality of the MAC modules or sending the output weight to at least one other multiplexer.

6. The method of claim 5, wherein the at least one multiplexer receives another weight from a weight memory that is different from the weight memory or from other multiplexer.

7. The method of claim 1, wherein the at least one CIM macro comprises an intra macro which comprises a first number of weight memories and a second number of MAC modules, wherein each of the first number of weight memories connects to a MAC module of the second number of MAC modules directly or by at least one multiplexer.

8. The method of claim 1, wherein the at least one CIM macro forms an inter macros, and each CIM macro of the at least one CIM macro comprises a weight memory and a MAC module, wherein each weight memory in the inter macros connects to at least one MAC module in the inter macros directly or by at least one multiplexer.

9. The method of claim 1, wherein the at least one CIM macro comprises at least one intra macro and inter macros, wherein:
each intra macro comprises a plurality of weight memories and a plurality of MAC modules; and
each CIM macro in the inter macros comprises a weight memory and a MAC module,
wherein each weight memory in at least one CIM macro connects to at least one MAC module in at least one CIM macro directly or by at least one multiplexer.

10. The method of claim 1, wherein the method is applied to a convolutional neural network (CNN) application.

11. A computing-in-memory (CIM) macro, comprising:
a plurality of weight memories, each of the plurality of weight memories is configured to store weights; and
a plurality of multiply and accumulation (MAC) modules, wherein each of the plurality of the MAC modules is connected to at least one of the plurality of weight memories directly or by at least one multiplexer to obtain the weights stored by the at least one weight memory.

12. The CIM macro of claim 11, wherein the CIM macro is an intra macro.

13. The CIM macro of claim 11, wherein the CIM macro is a first CIM macro, the first CIM macro comprises a first weight memory which is connected to at least one MAC modules outside the first CIM macro directly or by at least one multiplexer, and the weights stored in the first weight memory are accessed by the at least one MAC modules outside the first CIM macro.

14. The CIM macro of claim 11, wherein when a MAC module is connected to at least one weight memory of the plurality of weight memories by at least one multiplexer, each of the at least one multiplexer is configured to select one of its input weights as output weight and sends the output weight.

15. A computing-in-memory (CIM) macro, comprising:
a weight memory, configured to store weights; and
a multiply and accumulation (MAC) module, connected to the weight memory directly or by a multiplexer,
wherein the weight memory is connected to at least one MAC module outside the CIM macro directly or by at least one multiplexer, and the weights stored in the weight memory are accessed by the at least one MAC module outside the CIM macro.

16. The CIM macro of claim 15, wherein the MAC module is further connected to at least one weight memory outside the CIM macro directly or by at least one multiplexer to obtain the weights stored by the at least one weight memory outside the CIM macro.

17. The CIM macro of claim 15, wherein the CIM macro is a part of inter macros, wherein each CIM macro in the inter macros comprises a weight memory and a MAC module;
Wherein each weight memory in the inter macros is connected to at least one MAC module in the inter macros directly or by at least one multiplexer.

18. The CIM macro of claim 15, wherein when a MAC module is connected to a weight memory by at least one multiplexer, each of the at least one multiplexer is configured to select one of its input weights as output weight and send the output weight.
